(19) United States
(12) Patent Application Publication
(10) Pub. No.: US 2017/0153456 A1
(43) Pub. Date: Jun. 1, 2017

(54) UNIVERSAL JOINT MODULE AND HEAD-MOUNTED DISPLAY DEVICE

(71) Applicant: Coretronic Corporation, Hsin-Chu (TW)

(72) Inventors: Wei-Cheng Huang, Hsin-Chu (TW); Chin-Sheng Chao, Hsin-Chu (TW); Chun-Yao Chen, Hsin-Chu (TW); Ming-Chen Liu, Hsin-Chu (TW); Chih-Lung Chen, Hsin-Chu (TW)

(21) Appl. No.: 15/190,183

(22) Filed: Jun. 23, 2016

(30) Foreign Application Priority Data
Nov. 30, 2015 (TW) 104139865

(51) Int. Cl. G02B 27/01

(52) U.S. Cl. CPC G02B 27/0176; G02B 27/0149; G02B 2027/0154

(57) ABSTRACT

A universal joint module includes a base, a first bearer, a rotor, a fastening member, and an elastic member. The base has an inner space, a hole, and an opening opposite to the hole communicating with the inner space. The first bearer is disposed in the inner space. The rotor includes a knob rotatably disposed in the inner space and leant against the first bearer, and a shaft connected to the knob and passing through the hole. The fastening member is located in the inner space and close to the opening, and movably fastened to the base to adjust a distance between the fastening member and the first bearer. The elastic member located between the first bearer and the fastening member presses the first bearer to preserve a stress between the first bearer and the knob.

A head-mounted display device using the universal joint is also provided.

### CROSS-REFERENCE TO RELATED APPLICATION

This application claims the priority benefit of Taiwan application Ser. No. 104139865, filed on Nov. 30, 2015. The entirety of the above-mentioned patent application is hereby incorporated by reference herein and made a part of this specification.

### BACKGROUND OF THE INVENTION

1. [Field of the Invention]

The invention relates to a joint module and a display device and more particularly relates to a universal joint module and a head-mounted display device.

2. [Description of Related Art]

Head-mounted devices integrated with electronic modules have been developed in recent years for the user to wear the electronic module on the head with the rapid development of technology. For example, a display module may be disposed on a head-mounted electronic device to provide images to the user directly. The display module may be disposed on the head-mounted device through a universal joint, thus, the user can adjust the display module to an appropriate angle.

In the conventional universal joint, the knob is generally contacted with a surface of the base, and the friction generated when the knob moves relative to the base functions as a damper for holding the knob at different positions with respect to the base. However, a gap may be formed between the knob (usually made of a metal) and the base (usually made of plastic) due to abrasion after being used for some time. As a result, the knob may not be fully contacted with the base to be fastened and the display module may droop accordingly.

The information disclosed in this Description of Related Art section is only for enhancement of understanding of the background of the described technology and therefore it may contain information that does not form the prior art that is already known to a person of ordinary skill in the art. Further, the information disclosed in the Description of Related Art section does not mean that one or more problems to be resolved by one or more embodiments of the invention were acknowledged by a person of ordinary skill in the art.

### SUMMARY OF THE INVENTION

The invention provides a universal joint module that has a longer lifetime.

The invention provides a head-mounted display device that includes the universal joint module.

Other features and advantages of the invention may be understood through this disclosure.

In view of one, part of, or all of the aforementioned or other features, an embodiment of the invention provides a universal joint module that includes a base, a first bearer, a rotor, a fastening member, and at least one elastic member. The base has an inner space, a hole communicating with the inner space, and an opening opposite to the hole communicating with the inner space. The first bearer is located in the inner space. The rotor includes a knob and a shaft connected to the knob. The knob is rotatably disposed in the inner space and leant against the first bearer, and the shaft passes through the hole. The fastening member is located in the inner space and close to the opening, and movably fixed to the base to adjust a distance between the fastening member and the first bearer. The at least one elastic member is disposed in the inner space and located between the first bearer and the fastening member. The at least one elastic member is pressed by the fastening member to push the first bearer, so as to preserve a stress between the first bearer and the knob.

Another embodiment of the invention provides a head-mounted display device that includes a frame, a display device, and the universal joint module. The frame is adapted to be worn by a user. The display device is adapted to provide an image beam to the user. The universal joint module is pivoted to the frame and the display device.

Based on the above, the embodiments of the invention achieve at least one of the following advantages or effects. In the universal joint module of the invention, the elastic member is pressed by the adjustable fastening member to push the first bearer so as to preserve the stress between the first bearer and the knob. Thereby, the first bearer provides sufficient friction for the knob, and the knob may be rotated with respect to the first bearer and be fastened at a desired position. Accordingly, the rotor has a stable torque value and the universal joint module has a longer lifetime.

Other objectives, features and advantages of the invention may be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic view of a head-mounted display device according to an embodiment of the invention.

FIG. 2 is a schematic cross-sectional view of a universal joint module of the head-mounted display device of FIG. 1 along the plane A.

FIG. 3 is a schematic exploded view of the universal joint module of the head-mounted display device of FIG. 1.

FIG. 4, FIG. 5A and FIG. 5B are schematic cross-sectional views of a universal joint module from different aspects according to another embodiment of the invention.

FIG. 6A and FIG. 6B are schematic cross-sectional views of a universal joint module according to yet another embodiment of the invention.

FIG. 7 is a schematic view showing configuration of an elastic member of a universal joint module according to yet another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

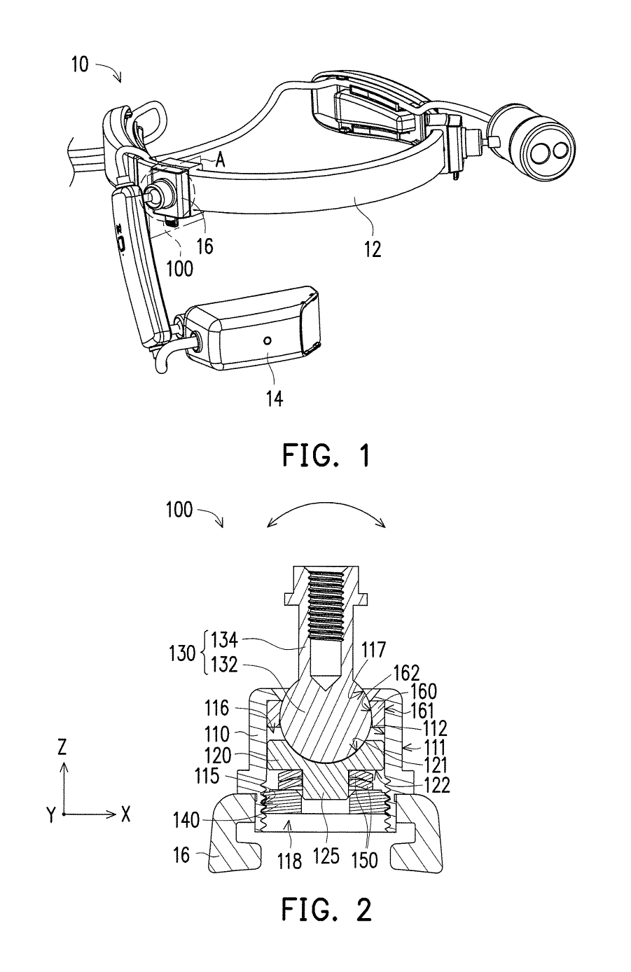

FIG. 1 is a schematic view of a head-mounted display device according to an embodiment of the invention. Referring to FIG. 1, a head-mounted display device 10 of this embodiment includes a frame 12, a display device 14, a connection groove base 16, and a universal joint module 100. The frame 12 is adapted to be worn by a user on the user's head. The connection groove base 16 is connected to the frame 12 and is movable on the frame 12. The display device 14 is pivoted to the connection groove base 16 through the universal joint module 100. The display device 14 is adapted to provide an image beam to the user. The user may adjust the display device 14 to an optimal viewing angle through the universal joint module 100 of the head-mounted display device 10 in this embodiment. Details of the universal joint module 100 are described hereinafter.

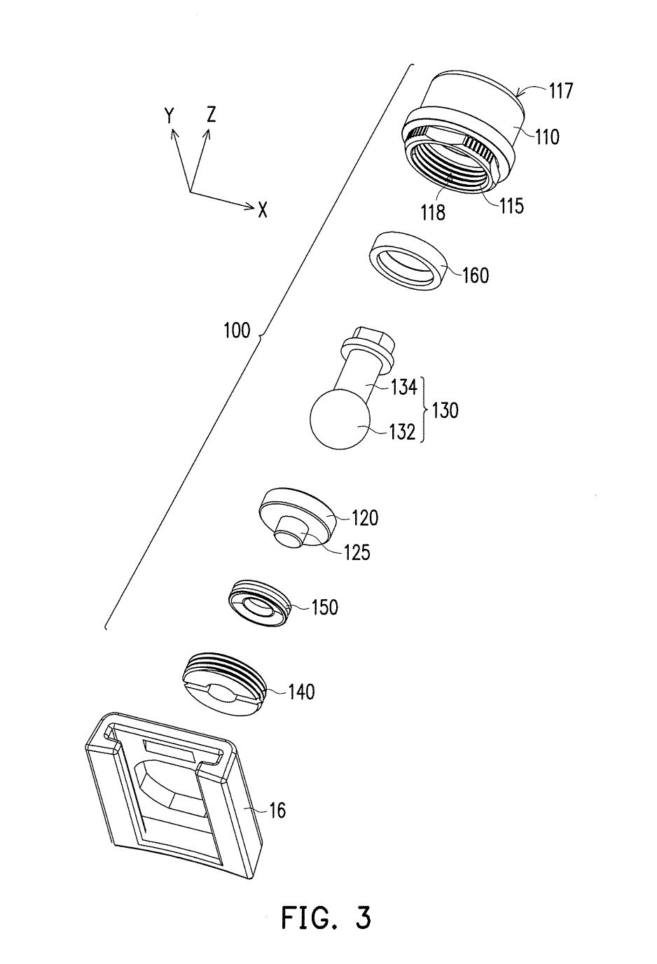

FIG. 2 is a schematic cross-sectional view of the universal joint module 100 of the head-mounted display device 10 of FIG. 1 along the plane A. FIG. 3 is a schematic exploded view of the universal joint module 100 of the head-mounted display device 10 of FIG. 1. Referring to FIG. 2 and FIG. 3, the universal joint module 100 of this embodiment includes a base 110, a first bearer 120, a rotor 130, a fastening member 140, at least one elastic member 150 and a second bearer 160. In this embodiment, the base 110 is bell-shaped and has an inner space 116, a hole 117 that communicates with the inner space 116, and an opening 118 opposite to the hole 117 communicates with the inner space 116. The connection groove base 16 is fixed to a base outer side surface 111 of the base 110 and is close to the opening 118.

The rotor 130 includes a knob 132 and a shaft 134 connected to the knob 132. The knob 132 is rotatably disposed in the inner space 116 and the shaft 134 passes through the hole 117 of the base 110. The shaft 134 may be connected to the display device 14. In this embodiment, a diameter of the knob 132 is greater than a bore diameter of the hole 117, such that the knob 132 does not fall out of the base 110.

The first bearer 120 is located in the inner space 116 at a position close to the opening 118, and the second bearer 160 is located in the inner space 116 at a position close to the hole 117. That is, in this embodiment, the first bearer 120 is located under the knob 132 in FIG. 2, and the second bearer 160 is located near the upper part of the knob 132 in FIG. 2. The knob 132 is leant against the first bearer 120 and the second bearer 160 respectively.

Specifically, the first bearer 120 has a first surface 121, a second surface 122 opposite to the first surface 121, and a column 125 protruded toward the fastening member 140. In this embodiment, the first surface 121 is a surface of the first bearer 120 that faces upward (a positive Z direction of FIG. 2) and the first surface 121 is supported to and abutted against the knob 132. The second surface 122 is a surface that faces downward (a negative Z direction of FIG. 2) and the elastic member 150 is contacted with the second surface 122. The second bearer 160 is ring-shaped and has a third surface 161 and a fourth surface 162 opposite to the third surface 161. In this embodiment, the third surface 161 is an outer surface of the second bearer 160 and the third surface 161 is contacted with the base 110. The fourth surface 162 is an inner surface of the second bearer 160 and is leant and abutted against the knob 132.

In this embodiment, a material of the base 110 has a hardness greater than s a hardness of materials of the first bearer 120 and the second bearer 160. A material of the knob 132 has a hardness greater than the hardness of the materials of the first bearer 120 and the second bearer 160. For example, the material of the knob 132 may be steel, the material of the base 110 may be aluminum or steel, and the materials of the first bearer 120 and the second bearer 160 may be copper alloy or other soft metals, or the materials of the first bearer 120 and the second bearer 160 may be plastic, however, the invention is not limited thereto. The materials of the first bearer 120 and the second bearer 160 are softer than the material of the knob 132, so as to reduce abrasion of the knob 132.

As shown in FIG. 2, the at least one elastic member 150 is disposed in the inner space 116 and located between the first bearer 120 and the fastening member 140. In this embodiment, the number of the elastic members 150 is two, however, the number of the elastic members 150 may also be one or three or more, the invention is not limited thereto. The elastic member 150 is metal, plastic, or other materials that may provide elastic stress. Each of the elastic member 150 is a hollow bowl-shaped elastic sheet and bore diameters of two ends of the elastic sheet are different. In other embodiments, the elastic member 150 may be a spring or other suitable elastic components. The elastic member 150 may be sleeved at the column 125 through the hollow space of the elastic member 150, so as to fix the relative positions of the elastic member 150 and the first bearer 120. In the embodiment, the two elastic members 150 are stacked with each other.

A base inner side surface 112 of the base 110 has an inner thread 115 close to the opening 118. The fastening member 140 is located in the inner space 116 and is close to the opening 118. The fastening member 140 is movably fastened to the base 110 for adjusting a distance between the fastening member 140 and the first bearer 120. In this embodiment, the fastening member 140 comprises a screw, and the fastening member 140 is fastened to the base 110 in an up and down manner along the Z axis through the inner thread 115. The fastening member 140 located near the opening 118 of the base 110 may block impurities such as dust to prevent the impurities entering into the inner space 116 of the base 110, so as to not to influence the torque of the knob 132.

In this embodiment, the user may adjust the relative positions of the fastening member 140 and the base 110. The elastic member 150 is pressed by the fastening member 140 to push the first bearer 120, so as to preserve a certain stress between the first bearer 120 and the knob 132. Accordingly, the first bearer 120 may continuously apply a stable stress on the knob 132 through the elastic member 150. Even if a gap is formed between the first bearer 120 and the knob 132 due to abrasion after a long time of use, the user may adjust the position of the fastening member 140 on the base 110 (for example, rotate the fastening member 140 to move upward along the positive Z axis in FIG. 2) for the elastic member 150 to provide sufficient stress to push the first bearer 120, so as to effectively reduce the gap between the knob 132 and the first bearer 120. The knob 132 is abutted against the second bearer 160 more closely as being pushed through the first bearer 120, where the gap between the knob 132 and the second bearer 160 may also be reduced. Therefore, the universal joint module 100 of this embodiment stabilizes the torque value of the ball rotor 130 and has a longer lifetime.

It should be noted that the knob 132 of the universal joint module 100 is simultaneously covered by the first bearer 120 and the second bearer 160 in this embodiment, so as to achieve the effects of stable and smooth rotation. In other embodiments, the second bearer 160 may be omitted if the first bearer 120 and the elastic member 150 are able to provide sufficient stress to cause the first bearer 120 to abut against the knob 132, however, the invention is not limited thereto.

Moreover, in this embodiment, a first bearer outer side surface of the first bearer 120 and a second bearer outer side surface of the second bearer 160 is closely abutted against the base inner side surface of the base 110 respectively, such that the first bearer 120 and the base 110 and the second bearer 160 and the base 110 do not move with respect to each other. Other structures may also be disposed between the first bearer 120 and the base 110 and between the second bearer 160 and the base 110 to prevent relative movement thereof, the invention is not limited thereto.

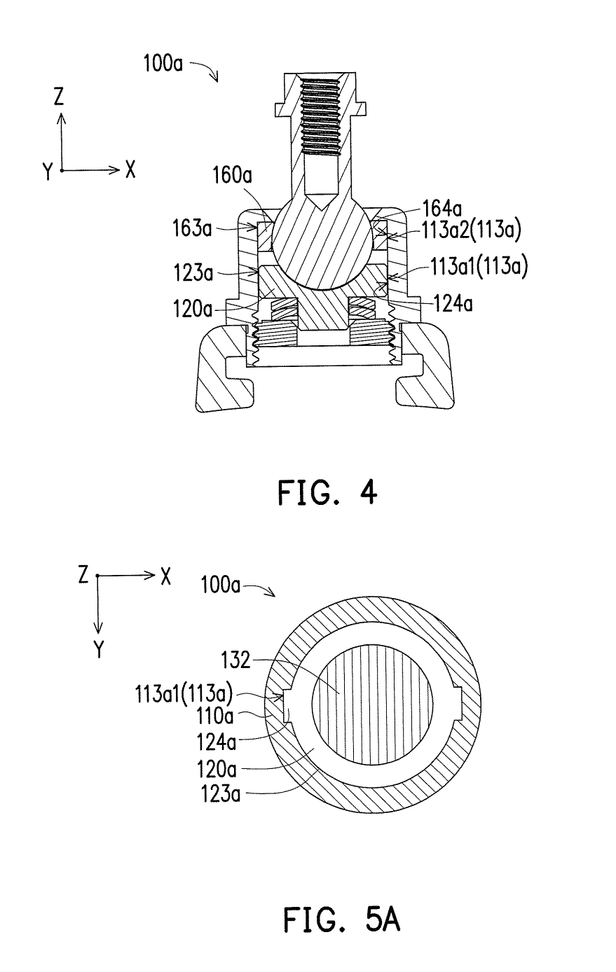

FIG. 4, FIG. 5A, and FIG. 5B are schematic cross-sectional views of a universal joint module from different aspects according to another embodiment of the invention. FIG. 4 is a schematic cross-sectional view of a universal joint module 100a on X-Z plane. FIG. 5A and FIG. 5B are schematic cross-sectional views of a first bearer 120a and a second bearer 160a of the universal joint module 100a respectively on X-Y plane. Referring to FIG. 4, FIG. 5A and FIG. 5B, the universal joint module 100a is similar to the universal joint module 100, the difference between the universal joint module 100 and 100a is that the base 110a of the universal joint module 100a includes a fastening part 113a located on the base inner side surface, and the fastening part 113a may be further divided into a lower fastening part 113a1 and an upper fastening part 113a2. In this embodiment, the lower fastening part 113a1 and the upper fastening part 113a2, for example, are two grooves with the same widths that communicate with each other in the Z direction. The first bearer 120a includes a first fastening part 124a located on a first bearer outer side surface 123a corresponding to the lower fastening part 113a1. The second bearer 160a includes a second fastening part 164a located on a second bearer outer side surface 163a corresponding to the upper fastening part 113a2.

In this embodiment, the second fastening part 164a includes two bumps that respectively protrude on the first bearer outer side surface 123a and the second bearer outer side surface 163a. The width of the first fastening part 124a and the second fastening part 164a are matched with the width of the lower fastening part 113a1 and the upper fastening part 113a2. The first bearer 120a is fastened to the base 110a by matching with the first fastening part 124a and the lower fastening part 113a1. The second bearer 160a is fastened to the base 110a by matching with the second fastening part 164a and the upper fastening part 113a2. Thereby, the relative positions between the first bearer 120a and the base 110a and between the second bearer 160a and the base 110a are fixed, such as not to move or rotate with each other. It should be noted that the lower fastening part 113a1 and the upper fastening part 113a2 may be two grooves that are separated from each other or have different widths. For example, the first fastening part 124a and the second fastening part 164a may respectively match with the width of the lower fastening part 113a1 and the width of the upper fastening part 113a2. Thus, the installing sequence of the first bearer 120a and the second bearer 160a may be avoided into a wrong order. The invention is not limited thereto.

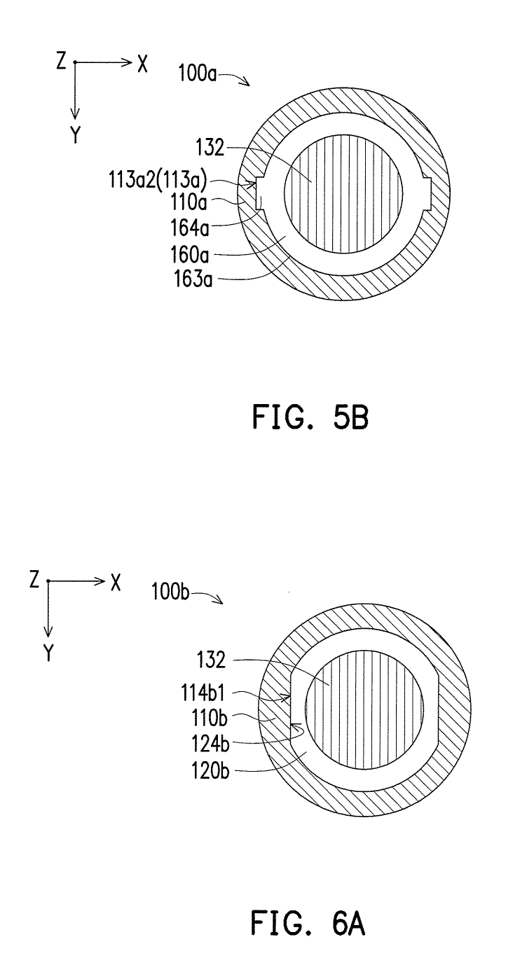

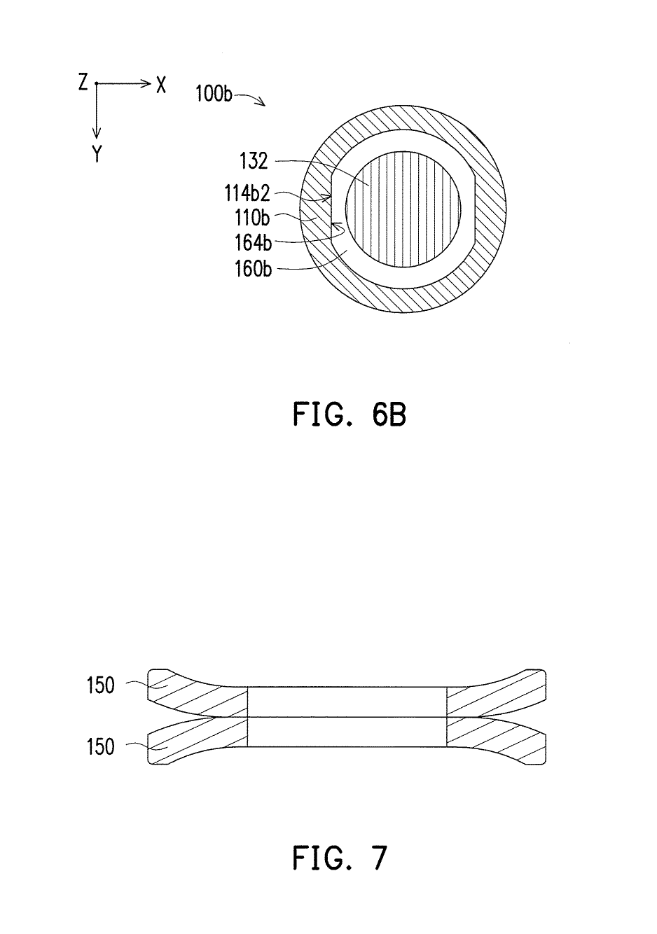

FIG. 6A and FIG. 6B are schematic cross-sectional views of a universal joint module according to yet another embodiment of the invention. FIG. 6A and FIG. 6B are schematic cross-sectional views of a first bearer 120b and a second bearer 160b of a universal joint module 100b respectively on the X-Y plane. Referring to FIG. 6A and FIG. 6B, the universal joint module 100b is similar to the universal joint module 100a. The relative positions of a base 110b and the first bearer 120b are fastened by matching with a first fastening part 124b of the first bearer 120b and a lower fastening part 114b1 of the base 110b. The relative positions of the base 110b and the second bearer 160b are fastened by matching with a second fastening part 164b of the second bearer 160b and an upper fastening part 114b2 of the base 110b. In this embodiment, the difference between the universal joint module 100b and 100a is that a cross section of a base inner side surface of the base 110b is a non-circular geometric shape. A cross section of a first bearer outer side surface of the first bearer 120b and a cross section of a second bearer outer side surface of the second bearer 160b are both corresponding to the shape of the cross section of the base inner side surface. More specifically, the cross section of the base inner side surface is a shape that cutting a periphery of a circle to form two straight sides opposite with each other. Thus, the first bearer 120b and the base 110b are engaged due to their shapes and do not move or rotate with respect to each other. Similarly, the second bearer 160b and the base 110b are engaged due to their shapes and do not move or rotate with respect to each other.

In addition, referring to FIG. 2, the two elastic members 150 of the universal joint module 100 are stacked with each other that the two bowls are arranged in the same direction along the Z axis. Therefore, the two elastic members are strongly bonded to enhance rigidity and not to be easily deformed. Thus, the two elastic members 150 achieve better positioning stability in comparison with only one single elastic member 150. Nevertheless, the disclosure is not intended to limit how multiple elastic members 150 are stacked. FIG. 7 is a schematic view showing configuration of the elastic member of a universal joint module according to yet another embodiment of the invention. Referring to FIG. 7, in this embodiment, the two elastic members 150 are arranged in opposite directions. That is, the two elastic members 150 are stacked in a bottom-to-bottom manner, so as to generate a stronger elastic stress. It should be noted that the two elastic members 150 are used here only as an example. In other embodiments, the number of the elastic members 150 may be three or more. Moreover, the elastic members 150 may be arranged in the manner as shown in FIG. 2, FIG. 7, or a combination thereof.

In summary, the embodiments of the invention achieve at least one of the following advantages or effects. In the universal joint module of the invention, the elastic member is pressed by the adjustable fastening member to push the first bearer so as to preserve the stress between the first bearer and the knob and thereby ensure that the first bearer provides sufficient friction for the knob and that the knob may be smoothly rotated with respect to the first bearer and be fastened at a desired position. Accordingly, the rotor has a stable torque value and the universal joint module has a longer lifetime.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A universal joint module, comprising:
a base comprising an inner space, a hole communicating with the inner space, and an opening opposite to the hole communicating with the inner space;
a first bearer located in the inner space;
a rotor comprising a knob and a shaft connected to the knob, wherein the knob is adapted to be rotatably disposed in the inner space and leant against the first bearer, and the shaft is adapted to pass through the hole;
a fastening member located in the inner space and being close to the opening, wherein the fastening member is adapted to be movably fixed to the base to adjust a distance between the fastening member and the first bearer; and
at least one elastic member disposed in the inner space and located between the first bearer and the fastening member, wherein the at least one elastic member is adapted to be pressed by the fastening member to push the first bearer, so as to preserve a stress between the first bearer and the knob.

2. The universal joint module according to claim 1, wherein the first bearer comprises a first surface and a second surface opposite to the first surface, the first surface is supported to and abutted against the knob, and the elastic member is contacted with the second surface.

3. The universal joint module according to claim 1, wherein a first bearer outer side surface of the first bearer is closely abutted against a base inner side surface of the base.

4. The universal joint module according to claim 3, wherein a cross section of the base inner side surface has a non-circular geometric shape, and a shape of a cross section of the first bearer outer side surface corresponds to the shape of the cross section of the base inner side surface.

5. The universal joint module according to claim 1, wherein the base comprises a lower fastening part located on the base inner side surface, the first bearer comprises a first fastening part located on the first bearer outer side surface and corresponding to the lower fastening part, and the first bearer is fastened to the base by matching with the first fastening part and the lower fastening part.

6. The universal joint module according to claim 1, wherein a hardness of a material of the base is greater than a hardness of a material of the first bearer, and a hardness of a material of the knob is greater than the hardness of the material of the first bearer.

7. The universal joint module according to claim 1, wherein the first bearer comprises a column protruding toward the fastening member, and the elastic member is sleeved at the column.

8. The universal joint module according to claim 1, further comprising:
a second bearer located in the inner space and being close to the hole, wherein the knob is leant against the second bearer.

9. The universal joint module according to claim 8, wherein the second bearer is ring-shaped and comprises a third surface and a fourth surface opposite to the third surface, wherein the third surface is contacted with the base and the fourth surface is leant and abutted against the knob.

10. The universal joint module according to claim 8, wherein a second bearer outer side surface of the second bearer is closely abutted against the base inner side surface of the base.

11. The universal joint module according to claim 10, wherein the cross section of the base inner side surface has a non-circular geometric shape, and a shape of a cross section of the second bearer outer side surface corresponds to the shape of the cross section of the base inner side surface.

12. The universal joint module according to claim 8, wherein the base comprises an upper fastening part located on the base inner side surface, the second bearer comprises a second fastening part located on the second bearer outer side surface and corresponding to the upper fastening part, and the second bearer is fastened to the base by matching with the second fastening part and the upper fastening part.

13. The universal joint module according to claim 8, wherein a hardness of a material of the base is greater than a hardness of a material of the second bearer, and the hardness of the material of the knob is greater than the hardness of the material of the second bearer.

14. The universal joint module according to claim 1, wherein the at least one elastic member are two or more elastic sheets, each of the elastic sheet has hollow bowl-shaped and bore diameters of two ends of the elastic sheet are different, wherein the two or more elastic sheets are stacked together.

15. The universal joint module according to claim 1, wherein a base inner side surface of the base has an inner thread close to the opening, and the fastening member comprises a screw and the fastening member is movably fastened to the base through the inner thread.

16. The universal joint module according to claim 1, wherein a diameter of the knob is greater than a bore diameter of the hole.

17. A head-mounted display device, comprising:
a frame adapted to be worn by a user;
a display device adapted to provide an image beam to the user; and
the universal joint module of claim 1, wherein the universal joint module is adapted to be pivoted to the frame and the display device.

18. The universal joint module according to claim 17, further comprising:
a connection groove base fixed to a base outer side surface of the base and being close to the opening, wherein the connection groove base is adapted to connect to the frame.
